(19) United States
(12) Patent Application Publication
(10) Pub. No.: US 2006/0013648 A1
(43) Pub. Date: Jan. 19, 2006

(54) Vise stationary jaw quick locking system

(75) Inventor: Leon M. Bernstein, Minnetonka, MN (US)

Correspondence Address: WESTMAN CHAMPLIN & KELLY, P.A., SUITE 1400 - INTERNATIONAL CENTRE, 900 SECOND AVENUE SOUTH, MINNEAPOLIS, MN, 55402-3319, US

(73) Assignee: Kurt Manufacturing Company, Inc., Minneapolis, MN (US)

(21) Appl. No.: 10/912,301

(22) Filed: Aug. 5, 2004

Related U.S. Application Data
(60) Provisional application No. 60/588,877, filed on Jul. 16, 2004.

(51) Int. Cl. B25B 1/24

(52) U.S. Cl. 403/374.4

(57) ABSTRACT

Pin lock assemblies are provided for a stationary vise jaw of a double vise two support surfaces of the vise rails. Each pin lock assembly has a pin housing that is threaded into a first bore in the respective vise rail, and which seats in a known position. Each pin housing has an outer end with a pair of oppositely facing generally conical surfaces, one of which mates with a conical surface at an outer end of the aligned first bore in the vise rail, and the other of which is an outer cone surface extends above the vise rail support surface. A slotted expanding sleeve is mounted over the outer end of the respective housing and has a mating, inwardly tapered interior cone surface to mate with the outer cone surface of the housing. Each pin lock assembly further includes a separate cone end collar that acts against a cone surface at an outer end of the slotted sleeve to cause the slotted sleeve to expand. The stationary vise jaw has a pair of bores that fit over the slotted sleeves of the aligned pin lock assemblies when the sleeves are not expanded, and when the stationary vise jaw is seated on the rail support surfaces, the stationary vise jaw is clamped tightly in place as each slotted sleeve is expanded and the vise jaw is forced against the rail support surfaces.

Reference is made to and priority is hereby claimed on U.S. Provisional Application Serial No. 60/______, filed Jul. 16, 2004, the content of which is incorporated by reference.

### BACKGROUND OF THE INVENTION

The present invention relates to a pin locking system for precisely positioning, securely tightening and locking two parts at assembly, primarily a stationary fixed jaw of a double vise onto a vise body quickly, easily, and reliably. The pin locking system permits removing and replacing a stationary vise jaw so that there are precisely positioned and tightened into proper position and held securely.

Generally, stationary vise jaws have been held on a vise body with capscrews that extend through bores in the stationary vise jaw, and with the threads of the cap screw engaging threaded bores in two longitudinal rails or other portions of the vise body. In the prior art stationary vise jaws, a rib or key is provided on the jaw. The rib or key fits into a groove on the vise body to precisely position and carry the loads from clamping parts on both sides of the stationary jaw.

Also known are positioning systems with round or diamond shaped bores or holes which fit opposed locating elements on the vise body. The locating keys or bores of present stationary jaws require clearance with opposed elements to insure the fixed jaw can be assembled onto the vise. This means that the prior art stationary jaws of a double vises are assembled onto the vise body without a preload, and any clamping forces that are unequal at one end or the other of the stationary jaw will shift the stationary jaw out of perpendicularity relative to the direction of clamping force. This will dislocate the clamping parts of both stations (on opposite faces of the stationary jaw) of a double vise. The stationary jaw will not be positioned precisely across the vise.

### SUMMARY OF THE INVENTION

The present invention relates to a pin locking system to retain a stationary jaw of a vise, primarily on a double vise, across the vise and positioned perpendicular to the direction of clamping force on a vise body. Anchoring pins that will permit easy assembly and yet preload the stationary vise jaw, and clamp it tightly onto the support surface of the vise are provided.

Structurally, a pair of threaded pin housings are threaded into bores in longitudinal side rails or other mounting members of a vise body. The pin housings each include a outwardly flared cone surface that seats tightly on a mating upwardly facing cone seat around the bores in the longitudinal side rails of the vise body. The pin housings are positively centrally located by the mating cone surfaces and can be seated tightly to precisely position the pin housings on the vise body.

Each pin housing also has an outer pin lock portion that extends above the upper surfaces of the respective side rails, which are the support surfaces for the stationary vise jaw. The upper portion of the pin housing has a center bore, and the lower or distal end of the bore has an internal thread to receive a capscrew. The capscrew extends from the upper end of the pin housing and above the vise rail surface.

A slotted expanding sleeve with interior conical end surfaces at opposite ends is positioned on the capscrew. The first end cone surface of the expanding sleeve fits and seats on an inwardly tapered conical exterior surface on an upper end of the pin housing that is above the fixed jaw support surface. A separate collar with a cone wedge surface at one end is placed under the head of the capscrew. The cone wedge surface of the separate collar seats into the second end cone of the slotted expanding sleeve, so that as the capscrew is rotated and tightened, the surface under the capscrew head slides on an upper end surface of the collar that is under the head of the capscrew. The cone surface of the collar will be forced down against the second end interior cone surface of the expanding sleeve without rotating the cone surface of the collar on the mating internal cone surface of the slotted expanding sleeve. The cone surface of the first end of the slotted expanding sleeve (opposite from the collar) is also forced onto the cone outer surface of the upper end of the pin housing. The cone end of the collar and the cone end at the upper end of the pin housing act as wedges to expand the slotted expanding sleeve as the capscrew is tightened. The tightening of the capscrew simultaneously tightens or clamps the stationary vise jaw down onto the vise body.

The stationary vise jaw has bores that will fit over the slotted expanding sleeves of the two pin locks used when the slotted expanding sleeves are contracted. The capscrews are backed off so that the diameter of the slotted expanding sleeves contract and are not expanded. The stationary vise jaw bores will slide over the contracted split sleeves because they can be made with clearance for assembly. The stationary vise jaw rests on the upper surface of the side rails of the vise.

Once the slotted expanding sleeves, the capscrews, the collars, and the cones at the upper ends of the pin housing are inside the respective bore on the stationary jaw of the vise, and the stationary jaw is seated on the side rail upper surface, each capscrew is tightened to force the associated expanding, double internal cone slotted sleeve to expand outwardly. The action of the cone wedge of the collar being forced down by the head of the capscrew, and the cone surface on the upper end of the pin housing, that is securely slated on a cone counter bore of the respective threaded bore in the associated vise rail causes the slotted expanding sleeve to engage and preload against the inner surface of the bore in the stationary vise jaw. As the cap screws are tightened, the stationary vise jaw is forced against the jaw support surface of the vise.

The stationary jaw will be securely held and seated in its proper position. Two of the pin housings are used, one at each end of the stationary jaw, for proper positioning.

### BRIEF DESCRIPTION OF THE DRAWINGS

FIG. 1 is a perspective view of a double vise utilizing a stationary jaw quick change system made according to the present invention;

FIG. 2 is a schematic end elevational view of the vise of FIG. 1;

FIG. 3 is a top plan view of the vise shown in FIG. 2; and

FIG. 4 is an enlarged sectional view through one of the pin lock assemblies used to secure the stationary vise jaw according to the present invention.

### DETAILED DESCRIPTION OF THE PREFERRED EMBODIMENTS

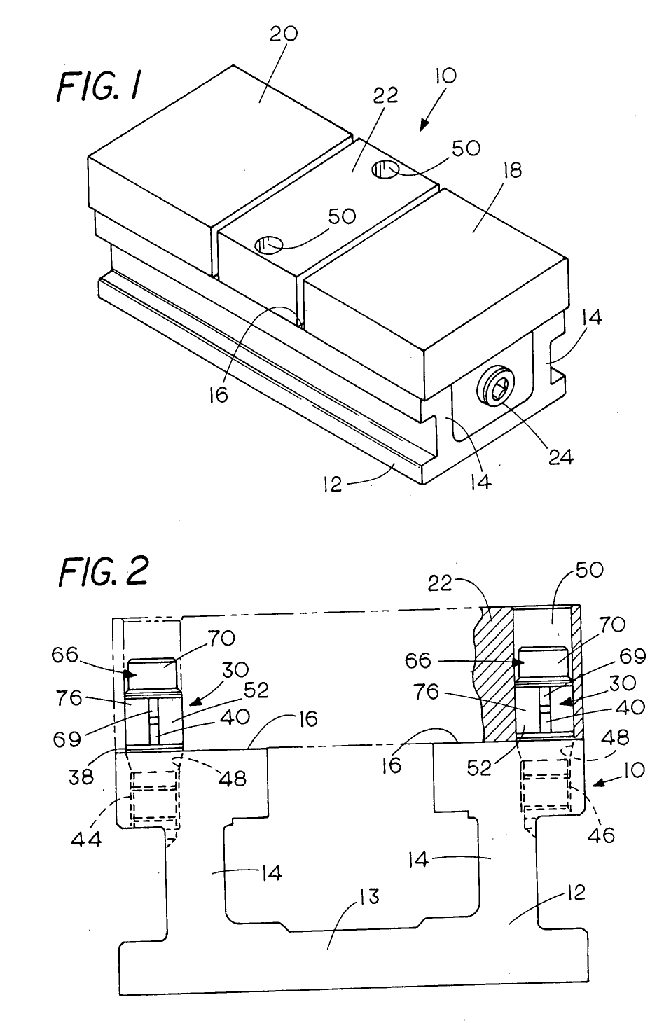

FIG. 1 illustrates a double station machine vise 10 that has a body 12, with a base wall 13 supporting spaced apart longitudinally extending side rails 14, each of which has a planar top surface 16 for supporting a work piece. A pair of movable jaws 18 and 20 mounted on the vise body and are supported on surface 16 of the rails 14. The movable jaws 18 and 20 are moved toward and away from a stationary, centrally located jaw 22 with a threaded screw 24 or other actuating device. The construction of the vise body, the movable jaw and the vise screw is conventional. The stationary jaw 22 is used for reacting clamping forces applied by the movable jaws 18 and 20. As can be seen, parts can be clamped against both surfaces of the stationary jaw 22.

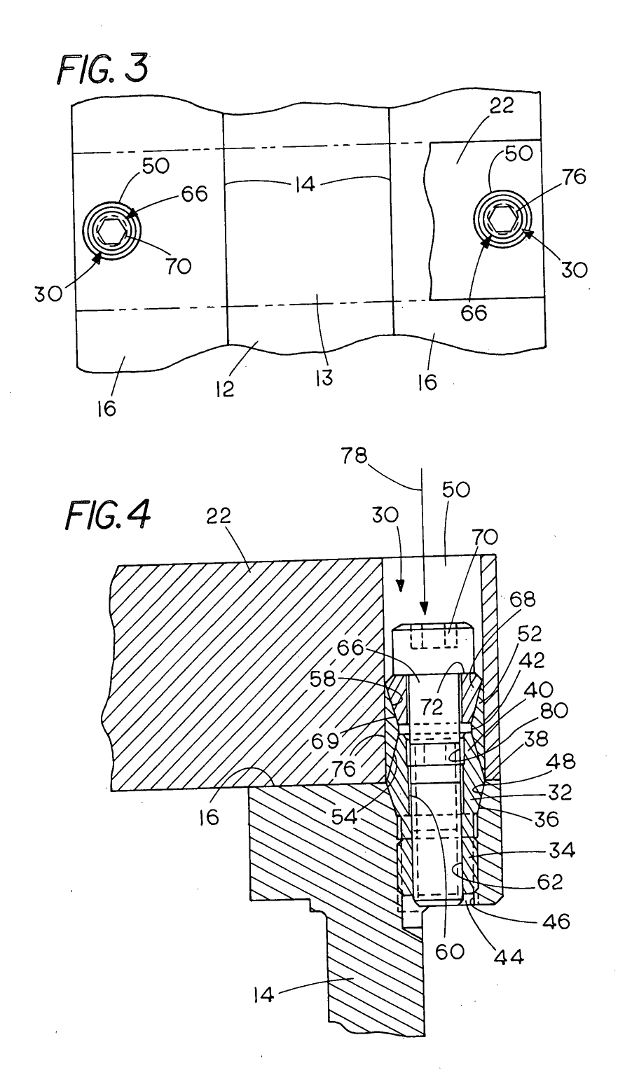

In the present invention, the stationary jaw 22 is mounted with pin locking system 30 (FIGS. 2-4) and can be quickly removed and replaced with another stationary jaw or the jaw that is removed can be turned upside down and replaced. Another stationary jaw may have a different clamp surface configuration, or be a special jaw.

The stationary jaw 22 is squeezed down in place against the upper surface 16 of the respective rails 14 with two pin locking systems or assemblies 30, shown in more detail in FIGS. 2 and 4.

Referring specifically to FIG. 4, each pin lock assembly 30 includes an outer pin housing 32 that is threaded into the respective bore 44 in the rails 14. The pin housing 32 has a threaded portion 34 at a lower or inner end as shown in FIG. 4. A mid portion of the pin housing 32 has a downwardly facing, outwardly flared cone surface 36. The surface 36 tapers from a maximum diameter portion 38 of the pin housing inwardly to the diameter of the threaded portion. The outer end of pin housing 32 has an outwardly and upwardly facing, inwardly tapered cone wedge surface 40 that is above the support surface 16 and extends from the maximum diameter portion 38 to a smaller diameter upper end 42 of the pin housing.

Each housing 32 is tightened down until the outwardly tapered conical surface 36 seats tightly on an inwardly tapered, upwardly facing mating cone seat surface 48 formed around the upper end of each bore 44. The surface 48 is a conical counter bore. This inwardly tapered cone seat surface 48 is open to the top surface 16 of the respective rail 14 and forms a seat for centering the inwardly tapered cone surface 36 of the pin housing 32. When the pin housing 32 is threaded tightly into its bore 44, the mating cone surfaces 36 and 48 center and tightly hold the pin housing in place.

The stationary jaw 22 has two cylindrical bores 50 that are substantially the same diameter as the diameter at part 38 of the pin housing 32. The bores 50 align with the pin housings in place in the bores 44 of the vise rails. The stationary jaw 22 is put into position on the surface 16 with the bores 50 over the respective pin clamp assembly 30.

In order to clamp the stationary jaw 22 securely on the pin housings 32 of the pin clamp assemblies, a capscrew 66 is threaded into a threaded end portion 62 of a bore 60 in each pin housing 32. The capscrew passes through a slotted expanding sleeve 52. The slotted expanding sleeve 52 has an internal cone end surface 54 at one end that mates with outer cone surface 40 on pin housing 32. The slotted expanding sleeve 52 also has an inner cone surface 58 at its opposite end. The slotted expanding sleeves are sized so that when the sleeves are not expanded, there is clearance with the bores 50 when the stationary vise jaw is placed onto the pin clamp assemblies 30.

A separate cone end wedge collar 68 is placed over the capscrew 66 under the head 70 of the capscrew 66 of each pin assembly. The cone wedge collar has an outwardly facing cone lower end surface 69 that seats on the inwardly tapered cone surface 58 at the upper end of the slotted expanding sleeve 52. The head 70 of the capscrew 66 slides on and bears against the surface of an upper end 72 of the cone wedge collar 68, so that when the capscrew 66 is threaded into the internally threaded section 62 of the pin housing 32, the cone surface 69 of the cone wedge collar 68 is forced against cone surface 58 without turning or rotating the collar 68. The surfaces 69 and 58 do not slide relative to each other. The cone surface 54 is also forced onto cone surface 40 on the pin housing 32. A wedging force is thus generated that expands the slotted expanding sleeve 52. The expanding outer surface 76 of the slotted expanding sleeve 52 then tightly engages and grips the inner surface of the respective bore 50 in the stationary vise jaw. As the capscrew is threaded inwardly, the slotted expanding sleeve 52 is forced down toward the jaw supporting surface 16 of the vise side rail, after the sleeve 52 has expanded to tightly grip the surface of bore 50. The stationary vise jaw 22 is therefore forced or clamped down onto the supporting surfaces 16 of the vise side rails 14.

If there is some flexing of the side rails so the upper surfaces 16 of the side rails vary in spacing during assembly of the stationary jaw, the spacing of the bores 44 used for mounting the stationary jaw on the vise rails can vary. The pin locking system permits enough clearance with the bores to accommodate variation in spacing and when the stationary jaw is in place and the pin locking system is actuated, it will pre-load the vise jaw by expanding the slotted sleeve to grip on the interior of the bores 50, and then clamp the stationary vise down.

The downward force obtained by tightening the capscrew 66, is indicated by the arrow 78 in FIG. 4. The inwardly tapered upper cone surface 36 of the pin housing 32 seats tightly against the outwardly tapered counter bore cone surface 48 at the upper end of the bore 44 in the rail 14, so the pin housing 32 is centered on the cone surface 48 and is seated rigidly in place.

The pin housing 32 has a hex shaped recess shown in cross section at 80 in FIG. 4, into which a hex drive wrench can be placed for tightly forcing the mating cone surfaces 48 and 36 to seat, and also to be held at the center of the bore 44.

Once pin housing 32 is tightened in place in the respective bore 44, the pin housing 32 will remain in place in the bore 44 on the vise rail or body with the cone surface 36 tightly seated on cone seat 48. The locking or expanding sleeve actuator capscrew 66 can be loosened, so the slotted expanding sleeve 52 will contract to its unloaded size to no longer grip the surface of the bore 50 in the stationary jaw 22. When both pin locks are released, the stationary jaw 22 can be removed. Both of the pin lock assemblies 30 will remain in its precisely located position on the vise rail or body.

To replace the stationary jaw 22, the jaw is moved so the bores 50 slide over the slotted sleeves 52. The capscrews 66 are tightened down to expand the slotted expanding sleeves 52 against the inner surfaces of the respective bores 50 and then to force the stationary vise jaw down against the support surface 16 to lock the stationary jaw precisely and securely in place. There can be sufficient clearance between the bores 50 and the sleeves 52 when the capscrews 66 are loosened to permit easy installation even if the vise rails flex or deflect relative to each other. Yet, by expanding the sleeve 52 so they lock on the bores 50, and then forcing the stationary jaw against surfaces 16 by further tightening the capscrews 66, the stationary vise jaw will be pre-loaded and held in place.

Again, the downwardly force from capscrews 66 will urge the stationary vise jaw against the support surfaces 16 after the cone surfaces act to expand the slotted expanding sleeves 52.

Although the present invention has been described with reference to preferred embodiments, workers skilled in the art will recognize that changes may be made in form and detail without departing from the spirit and scope of the invention.

What is claimed is:

1. A pin lock assembly for holding first and second parts together wherein the first and second parts have mating surfaces, a first bore in the first part, and a second bore in the second part, the first and second bores axially aligning when the first and second parts are in position, the pin lock assembly comprising a pin housing supportable in the first bore of the first part and securable at a fixed location on the first part; the pin housing having a third central bore and an upper end with an upwardly facing outer cone surface, a slotted expanding sleeve having an inner cone surface mating with the outer cone surface of the pin housing, the second bore of the second part fitting around the expanding sleeve with the expanding sleeve in a contracted position, and an axially movable actuator for expanding the expanding sleeve while the expanding sleeve is within the second bore of the second part.

2. The clamp assembly of claim 1, wherein the axially movable actuator comprises a cone end wedge member that engages a second end internal cone surface of the expanding sleeve upon axial movement of the cone end wedge member toward the first part.

3. The clamp assembly of claim 2, wherein said axially movable actuator comprises a threadable capscrew that threads into the third central bore of the pin housing, and which has a surface for moving the cone end wedge member axially against the second end inner cone surface of the expanding sleeve.

4. The clamp assembly of claim 3, wherein said cone end wedge member comprises a separate collar engaged by a head of the capscrew.

5. The clamp assembly of claim 1, wherein the first bore in the first part threadably receives the pin housing, and has a cone seat surrounding the first bore in the first part at an upper end of the first bore, and wherein the pin housing has a mating outer cone surface for seating on the cone seat surrounding the first bore to position the pin housing axially when the pin housing is threaded in place in the first bore in the first part.

6. The clamp assembly of claim 2, wherein the third central bore of said pin housing is threaded at an end opposite from an upper end of the third central bore, and wherein the axially movable actuator comprises a capscrew in the third central bore and threadably engaging the threaded portion of the third central bore.

7. The clamp assembly of claim 1, wherein the pin housing, the slotted expanding sleeve, and the axially movable actuator for the expanding slotted sleeve form an assembly on the first part, the second bore of the second part being placed on the slotted expanding sleeve of the formed assembly.

8. A pin clamp assembly for holding a stationary vise jaw onto a vise body, the vise body having a support surface that supports a mating surface on the stationary vise jaw, the vise body having a first bore therein, and the stationary vise jaw having a second bore therein, the first and second bores having first and second central axes, respectively, that align when the stationary vise jaw is positioned on the vise body, the clamp assembly comprising a housing threadably securable in the first bore of the vise body at a known position along the first central axis of the first bore, the housing having a portion that extends outwardly from the support surface of the vise body, and such outwardly extending portion having an outer cone surface that tapers inwardly from a maximum diameter of the housing adjacent a level of the support surface on the vise body and toward the first central axis of the first bore, a slotted sleeve having a sleeve bore and a first inner cone surface on a first end thereof positionable adjacent the support surface of the vise body and engaging the outer cone surface of the housing, and the slotted sleeve having a second inner cone surface at a second end thereof, the housing having a third central bore with an internally threaded portion, a screw passing through the sleeve bore and threadably mounted in the third central bore of the housing, and an actuator collar positioned on the screw and slidably engaged by a surface of a head of the screw, said actuator collar having an outer cone surface mating with the cone surface of the second end of the slotted sleeve, whereby moving the actuator collar toward the outer cone surface of the housing expands the slotted sleeve, and the second bore of the stationary vise jaw being slidable over the slotted sleeve when the slotted sleeve is in a first retracted position, the slotted sleeve expanding when the actuator collar is moved by threading the screw into the third central bore of the housing.

9. The clamp assembly of claim 8, wherein the slotted sleeve has an axially extending slot along a length of the slotted sleeve and extending between the first and second ends of the slotted sleeve.

10. The clamp assembly of claim 8, wherein the housing has a drive surface configuration for drivably threading the housing into the first bore.

11. The clamp assembly of claim 8, wherein the first bore joins an upwardly facing cone surface in the vise body surrounding the first bore and open to the support surface, the housing having a downwardly facing surface at a portion of the housing adjacent the support surface that seats against the upwardly facing cone surface of the vise body surrounding the first bore.

12. A pin clamp assembly for holding a stationary vise jaw onto a vise body, the clamp assembly comprising a pin housing, the pin housing having an external thread at a first end and having a second end portion including a first outer cone surface that tapers outwardly from a diameter of the first end to a maximum diameter, and a second outer cone surface that tapers inwardly from the maximum diameter, the housing having a central first bore, a slotted sleeve having a sleeve bore and a first inner cone surface on a first end thereof engaging the second outer cone surface of the pin housing, and the slotted sleeve having a second inner cone surface at a second end thereof, a screw passing through the sleeve bore and threadably mounted in the central bore of the pin housing, and an actuator collar positioned on the screw and slidably engaged by a surface of a head of the screw, said actuator collar having an outer cone surface mating with the cone surface of the second end of the slotted sleeve, whereby moving the actuator collar toward the outer cone surface of the pin housing expands the slotted sleeve.

13. The pin clamp assembly of claim 12, wherein the slotted sleeve has an axially extending slot along a length of the slotted sleeve and extending between the first and second ends of the slotted sleeve.

14. The clamp assembly of claim 12, wherein the pin housing has a drive surface configuration for drivably threading the external thread of the pin housing into a threaded bore.
